(19) United States
(12) Patent Application Publication
(10) Pub. No.: US 2004/0152035 A1
(43) Pub. Date: Aug. 5, 2004

(54) Orthodontic implant system for tooth mobilization

(76) Inventors: Axel Bumann, Berlin (DE); Rolf Scherberger, Muhlacker (DE)

Correspondence Address: HARNESS, DICKEY & PIERCE, P.L.C., P.O. BOX 828, BLOOMFIELD HILLS, MI, 48303, US

(21) Appl. No.: 10/751,361

(22) Filed: Jan. 5, 2004

Related U.S. Application Data
(63) Continuation of application No. PCT/EP02/06680, filed on Jun. 18, 2002.

(30) Foreign Application Priority Data
Jul. 5, 2001 (DE) 101 32 088.4

(51) Int. Cl. A61C 3/00

(52) U.S. Cl. 433/18; 433/174

(57) ABSTRACT

An orthodontic implant system for tooth mobilization, comprising an implant which has a shaft which can be implanted in a jawbone and a head adjoining the shaft, on which head fastening means are present in order to fix at least one tensioning or retaining element on the head. The fastening means have at least one elongate recess which is formed on the head and extends substantially transversely or obliquely to a longitudinal axis of the shaft and is open on at least one longitudinal end to receive a section of the at least one tensioning or retaining element. A curing or curable adhesive composition is provided for fixation of the section of the at least one tensioning and retaining element in the at least one recess.

### CROSS REFERENCE TO OTHER APPLICATIONS

The present application is a continuation of pending international patent application PCT/EP02/06680 filed on Jun. 18, 2002 which designates the United States and was published in German, and which claims priority of German patent application 101 32 088.4 filed on Jul. 5, 2001.

### BACKGROUND OF THE INVENTION

The invention relates to an orthodontic implant system for tooth mobilization.

An implant system of this type is disclosed in the article “Widening the orthodontic possibilities with the Aarhus anchorage®”, author Birte Melsen, which appeared in “The Peridontology and Oral Implantology Journal”, volume 19, No. Hors Series/2000.

An implant system of this type is used in orthodontics to correct tooth malpositionings. Such malpositionings may consist for example in tooth distances which are too large between adjacent teeth, in teeth standing in too close proximity, or in inclinations or positionings rotated around the tooth axis. Tooth malpositionings can be eliminated especially in children and adolescents by exerting traction or thrust or torque on the tooth or teeth to be corrected over a prolonged period in order gradually to move them into the correct position.

The tensioning or retaining element used in this connection are normally wires, rubber rings, plastic chains, metal helical springs and the like.

In earlier methods, the at least one tensioning or retaining element was fixed by means of a bracket to one or more teeth not requiring correction as anchorage point, and the at least one tensioning or retaining element was fastened at its other end to the tooth to be mobilized. However, the disadvantage of these original methods is that the tooth or teeth which serve as anchorage points for the at least one tensioning or retaining element are themselves mobilized owing to the principle of action and reaction. This makes it on occasion not straightforward to control the correction of the tooth malpositioning with this procedure.

This problem has been eliminated by providing an orthodontic implant of the type mentioned at the outset, since such an implant serves as immobile anchorage point for the at least one tensioning or retaining element. The implant is fastened not to another tooth but directly in the jawbone, normally at the level of the roots between the teeth.

The implant has a shaft which can be implanted in the jawbone, and to the shaft adjoining a head on which fastening means are present in order to fix the at least one tensioning or retaining element on the head and thus on the implant. A stationary immobile anchorage point for the at least one tensioning or retaining element is created thereby, and only the tooth or teeth which are to be mobilized are in fact moved into the desired position by the direct or indirect exertion of force by the at least one tensioning or retaining element.

In the implant system disclosed in the article mentioned at the outset, the fastening means have two intersecting slits recessed at the free end of the head, it being possible to place the at least one tensioning or retaining element in at least one of the slits. A wire ligature is used to fasten the at least one tensioning or retaining element in the at least one slit, i.e. the tensioning or retaining element is fastened by means of a thin steel wire on the head of the implant. It is to be regarded as disadvantageous in this case that the fastening of the at least one tensioning or retaining element on the implant is difficult to manipulate by the clinician in view of the minaturization of such implants. In addition, a smooth surface is not produced in the region of the head of the implant in the implanted state of the implant system, which may be felt to be unpleasant by the patient on contact with the tongue.

An anchorage screw comparable thereto is disclosed in WO 01/37752 A1, which is likewise used for tooth mobilization. This known anchorage screw has a head on which there is formed a peripheral groove into which a tensioning wire can be placed and wound around the periphery of the groove. For further fixation, two crossed continuous boreholes are also present in the screw head, and the tensioning wire can be additionally inserted into them for the fixation.

EP-A-0 823 244 furthermore discloses an implant which, as fastening means for fixation of the at least one tensioning or retaining element, has a hook or an eyelet which projects from the side of the head of the implant. However, this known implant thereby has the disadvantage that the manufacturing costs to form the hook projecting from the side of the head, or the eyelet, are high, in particular when it is remembered that such implants are miniaturized. The eyelet projecting from the side of the head, or the hook, may moreover easily be broken off, broken open and/or bent by leverage which is caused for example also by the at least one tensioning or retaining element. In addition, an unpleasant foreign-body sensation may arise for the patient, because of the hook projecting on the side or the eyelet projecting on the side, on contact with the tongue.

The formation of a hook projecting from the side of the head or of the projecting eyelet is disadvantageous for fabrication techniques because the head has, owing to the hook or eyelet, no rotational symmetry. It is accordingly proposed in the said document in a preferred embodiment to construct the implant in a plurality of parts, i.e. to produce the head and the shaft as separate parts and then to join them together by means of a screw on implantation. Overall, therefore, the known implant is constructed of three parts. However, the plurality of parts also makes the manipulation very difficult for the clinician to implant this known implant, especially in the light of the miniaturized embodiment of such an implant. Although it is also regarded as possible therein to produce the complete implant in one piece, this proves to be difficult for the reasons mentioned above.

### SUMMARY OF THE INVENTION

The present invention is therefore based on the object of providing an orthodontic implant system, in which the aforementioned disadvantages are avoided, in which in particular the complexity of fastening the at least one tensioning or retaining element on the implant is reduced, and which is felt to be less intrusive by the patient.

According to one aspect of the present invention, an orthodontic implanting system for tooth mobilization is provided, comprising: an implant having a shaft which can be implanted in a jawbone, and a head adjoining said shaft at one end of said shaft, fastening means on said head of said implant for fixing at least one elongate tensioning/retaining element on said head, said fastening means having at least one elongate recess for receiving a section of said at least one tensioning/retaining element, said recess being formed on said head and extending substantially transversely to a longitudinal axis of said shaft and being open on at least one side of said head, and a curable adhesive composition for fixing said section of said at least one tensioning/retaining element in said at least one recess.

The implant system according to the invention differs from the known system in that the at least one tensioning or retaining element is fixed in the at least one recess by means of a curing or curable adhesive composition, for example a plastic material, whereby the implant system according to the invention has the advantage that the fixation of the at least one tensioning or retaining element proves to be particularly simple for the clinician. The further advantage is that the adhesive composition forms a smooth cap on the head of the implant, which cap does not feel unpleasant to the patient on contact with the tongue. On the contrary, such an adhesive covering feels substantially no different than gum or oral mucosa, and thus the implant according to the invention experiences greater acceptance by the patient than the known implant.

In a preferred embodiment, the at least one recess is formed as slit recessed at the free end of the head.

It is advantageous in this case that the manipulation for putting the at least one tensioning or retaining element into the slit is very easy for the clinician, because the at least one tensioning or retaining element, for example a wire, can be put from the free end of the head into the slit. The slit is preferably open at both its longitudinal ends, thus further simplifying the putting in of the tensioning or retaining element.

In a further preferred embodiment, the depth of the slit is such that the slit can receive at least two tensioning or retaining elements one above the other.

The increased depth of the slit achieves the advantage not only that the at least one tensioning or retaining element can be fastened very securely in the slit after application of the adhesive composition, but also that it is possible with only one implant simultaneously to anchor at least two tensioning or retaining elements on the same implant, and these can then be fixed for example to different teeth.

Alternative to the embodiment of at least one recess as slit, it is possible to provide in a further preferred embodiment for the at least one recess to be formed as borehole in the head.

It is also possible in this case to bring about the fixation of the at least one tensioning or retaining element in the borehole by means of an adhesive which is curable or curing.

In a further preferred embodiment, the fastening means have at least two recesses.

Once again, this achieves the advantage that at least two tensioning or retaining elements and, with an appropriate depth or diameter of the at least two recesses, more than two tensioning or retaining elements can be fastened on the head of the implant. It is possible thereby to achieve a very stable anchorage of the point of action of the force which is applied to mobilize the tooth to be mobilized or the teeth to be mobilized.

In this context, it is preferred for the recesses to cross one another, preferably at right angles.

At least two tensioning or retaining elements can in this way advantageously lead away from the implant in different directions in order then to extend to different teeth.

In a further preferred embodiment, the free end of the head has a coning which tapers toward the free end of the head, with the at least one recess being formed in the coning.

This measure has the advantage that the adhesive composition, which is preferably in ductile form before curing and is pressed onto the free end of the head once the at least one tensioning or retaining element has been put into the at least one recess, experiences a particularly good hold on the head after curing.

It is further preferred in this connection, if a radially inwardly directed undercut adjoins the coning at an end opposite to the tapered end.

This undercut has the advantage that, on application of the adhesive composition to the head, it penetrates into the undercut and thus experiences an even better mechanical hold on the head after curing. In addition, the at least one tensioning or retaining element is then completely encircled by the adhesive composition in the region of the undercut and is thus fixed even more securely on the head of the implant.

In a further preferred embodiment, the shaft has a thread for screwing into the jawbone, and a polygon is formed around the head to fit a corresponding tool.

It is advantageous in this case for self-tapping screwing of the implant into the jawbone to be possible, in which case it is possible for the implant to be implanted in the jawbone in an easily manipulated way through the polygon on the head, which preferably adjoins the aforementioned undercut, by means of an appropriate tool, for example a miniaturized wrench.

In a further preferred embodiment, the shaft and the head are formed together in one piece.

The one-piece embodiment of the implant has the advantage that, despite minaturization of the implant, implantation is very straightforward for the clinician because it is unnecessary to join a plurality of parts together.

In a further preferred embodiment, the head and the shaft are fabricated from a rod-like solid material in a material-removing process.

This mode of fabrication of the implant according to the invention has the advantage that, owing to the fabrication from a solid material, the implant has great stability even with minaturization, because no soldered or welded joints are present and, in addition, can be fabricated in series production with large piece numbers in a short time for machine fabrication. An example of the material which can be used is a titanium alloy.

In a further preferred embodiment, the adhesive composition is in ductile form before application to the head and can be cured after application preferably by means of light.

This measure simplifies the manipulation of the implant system for fixation of the at least one tensioning or retaining element on the head of the implant, because the ductile adhesive composition can easily be pressed like modeling clay onto the head of the implant and experiences prefixation even during this, without running away or falling off the head of the implant again. Complete fixation of the at least one tensioning or retaining element then takes place by curing of the adhesive composition, preferably with light, on the head of the implant.

Further advantages are evident from the following description and the appended drawings.

It will be appreciated that the features mentioned above and to be explained hereinafter can be used not only in the particular combination indicated but also in other combinations or alone without departing from the scope of the present invention.

### BRIEF DESCRIPTION OF THE DRAWINGS

Exemplary embodiments of the invention are depicted in the drawing and are described in detail hereinafter with reference thereto. In the drawings:

FIG. 1 shows an implant of the implant system according to the invention on its own viewed from the side in a greatly enlarged scale;

FIG. 2 shows an implant system according to the invention with the implant in FIG. 1 and with an adhesive composition applied to the head of the implant after putting in a tensioning or retaining element;

FIG. 3 shows a view from the top of the implant in FIG. 1;

FIG. 4 shows a further perspective view of the implant in FIG. 1; and

FIGS. 5 to 7 show diagrammatic representations of some examples of the application of the implant system according to the invention.

### DETAILED DESCRIPTION OF PREFERRED EMBODIMENTS

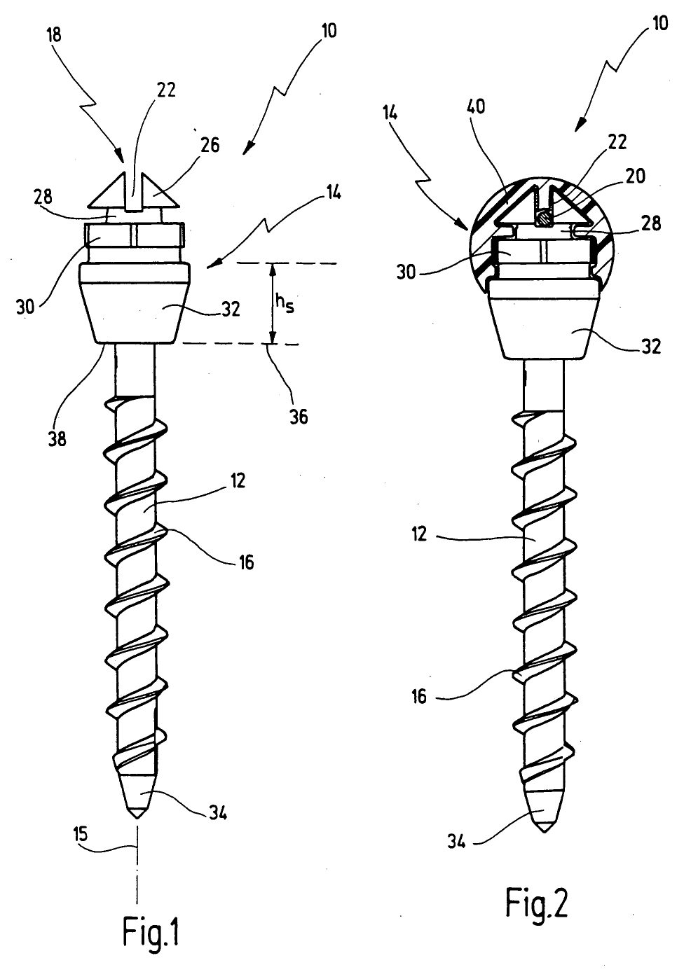

FIGS. 1 to 4 depict an orthodontic implant, which is provided with the general reference numeral 10, for tooth mobilization. The implant 10 is used in orthodontics for correcting tooth malpositionings, as will be described in detail later with reference to FIGS. 5 to 7.

The implant 10 has a shaft 12 which can be implanted in a jawbone which is not depicted. The shaft 12 is followed by a head 14 which in the present case is joined in one piece to the shaft 12.

The implant 10 is formed overall to be rotationally symmetrical around its longitudinal axis 15 which forms the longitudinal central axis or axis of symmetry of the implant 10.

The shaft 12 has a thread 16 so that the implant 10 can be screwed into the jawbone.

The head 14 has fastening means, which are provided with the general reference numeral 18, in order to fix at least one tensioning or retaining element 20 (depicted in FIG. 2) to the head 14, the tensioning or retaining element 20 being, for example, a wire, a spring, a chain or a rubber band.

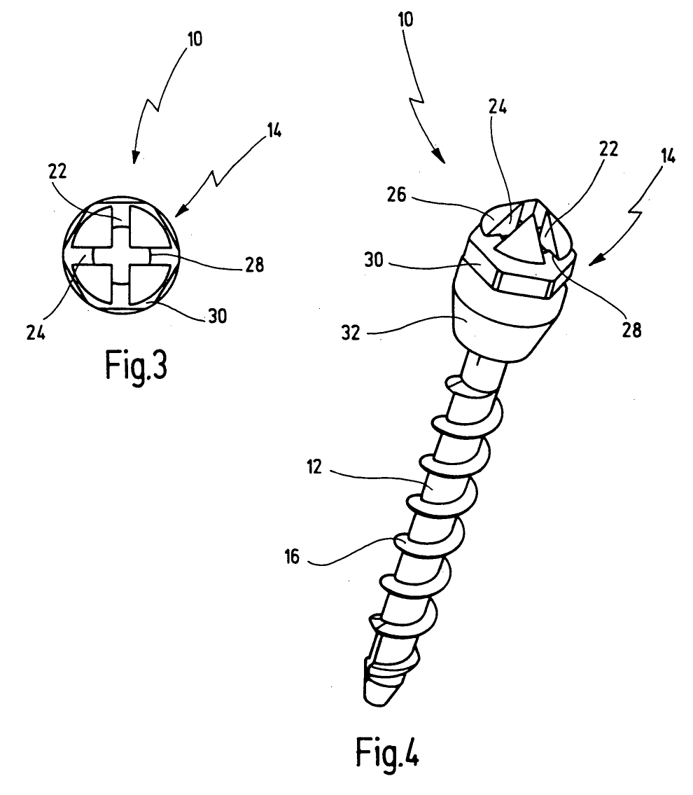

The fastening means 18 have at least one, in the exemplary embodiment shown two, elongate recesses 22 and 24 formed on the head 14, as can best be seen in the view from the top in FIG. 3. The recesses 22 and 24 are formed as slits which are recessed at the free end of the head 14 and which extend transversely to the longitudinal axis 15 of the shaft 12 and are open at at least one of their longitudinal ends, in the exemplary embodiment shown at each of their two longitudinal ends.

The two recesses 22 and 24 in the form of the slits are recessed in a coning 26 which is disposed at the free end of the head 14 and which tapers toward the free end of the head 14.

The two recesses 22 and 24 formed in the coning 26 run approximately at right angles to one another.

The head 14 has, at the end opposite to the free end of the head 14, an undercut 28 which directly adjoins the widened end of the coning 26 and is directed radially inward.

As is evident in particular from FIGS. 1 and 2, the recess 22 extends, and the recess 24 also extends, over the entire height of the coning 26 and moreover extends also into a subzone of the undercut 28.

The depth of the recesses 22 and 24 is chosen in every case so that their depth is greater than their diameter, so that each of the recesses 22 and 24 can receive at least two tensioning or retaining elements 20, for example two wires one on top of the other.

The undercut 28 is followed moreover by a polygon 30, in the exemplary embodiment shown a hexagon, to fit a corresponding tool, for example a wrench. The head 14 additionally has a base section 32 from which the shaft 12 extends away.

The implant 10 has overall a miniaturized design. The length of the shaft 12 is, for example, about 10 to 15 mm, specifically measured from the tip 34 to a line 36 which represents the junction of the shaft 12 with the base section 32 of the head 14. On implantation, the shaft 12 is screwed as far as about line 36 into the jawbone, using for this purpose a tool fitted on the polygon 30. An underside 38 of the base section 32 prevents the implant 10 being screwed too far into the jawbone, because the underside 38 forms a stop surface or limit stop on screwing in. A height hs of the base section 32 has dimensions such that it approximately corresponds to the thickness of the gum (gingiva). In practical cases, the height hs is about 1.5 to 2.5 mm. Thus, in the implanted state, only the coning 26 and the polygon 30 project out of the gum. The part, projecting out of the gum, of the head 14 has an overall height of about 0.8 to 1.3 mm. In this way, the implant is virtually not felt by the patient to be a foreign body.

The complete implant 10 is, as already mentioned, formed in one piece and is fabricated for example from a titanium alloy from a rod-like solid material through a material-removing process, for example by a turning process, which is advantageously possible with little complexity owing to the high rotational symmetry of the implant 10 according to the invention.

FIG. 2 depicts the implant 10 with the tensioning or retaining element 20 received in the recess 22, the wire-shaped element 20 being fixed by means of a curing or curable adhesive composition 40, for example a photocurable plastic. The adhesive composition 40 is pressed in the ductile state after implantation of the implant 10 into the jawbone and after putting in the at least one tensioning or retaining element 20 into the recess 22 on the head 14 of the implant 10, with, on the one hand, the coning 26 bringing about a prefixation of the adhesive composition 40, and with the adhesive composition 40 when pressed on also penetrating into the undercut 28 and thus surrounding the tensioning and retaining element 20. The adhesive composition 40 in this case also covers the polygon cap 30. After application of the adhesive composition 40 to the head 14, it is cured by means of light, for example UV light.

The adhesive composition 40 additionally forms in the cured state a smooth covering cap for the head 14 of the implant, which cap is not felt by the patient to be a foreign body on contact with the tongue, because the feeling on contact with the tongue is scarcely different from that when the tongue touches the gum. This is favored even further by the small overall height of the part, projecting out of the gum, of the head 14 of the implant 10.

FIGS. 5 to 7 depict diagrammatically three exemplary possibilities for application of the implant 10 from FIGS. 1 to 4.

FIGS. 5 to 7 depict four teeth in the lower jaw which are referred to by reference numeral 42 (cheek tooth) and 44, 46 and 48 (canines and incisors). The intention of an orthodontic treatment is to mobilize the tooth 42 in order to reduce the large gap between tooth 42 and tooth 44 without at the same time mobilizing tooth 44 or 46 or 48. The direction of the mobilization is made clear in FIGS. 5 to 7 by an arrow 50.

FIGS. 5 to 7 depict the implant 10 in the state implanted in the lower jawbone, which is not depicted, the implant 10 specifically having been screwed into the lower jawbone between the roots of the teeth 44 and 46. Correspondingly, in the view from the top the implant 10 can be seen on the head 14 owing to its implantation in the direction perpendicular to the axial direction of the roots of the teeth 44 and 46. The adhesive composition 40 from FIG. 2 has in this case been omitted from the drawing.

As shown in FIG. 5, one end of a tensioning or retaining element 52 is fastened to the head 14 of the implant 10, and the other end thereof is fastened via a bracket 54, which is normally used in orthodontics, to the tooth 42 which is to be mobilized. The tensioning element 52 has a spring section 56 which has the effect of exerting a traction on the tooth 42 in the direction of the arrow 50. This traction also acts on the implanted implant 10 which, however, is immovable so that only the tooth 42 is mobilized.

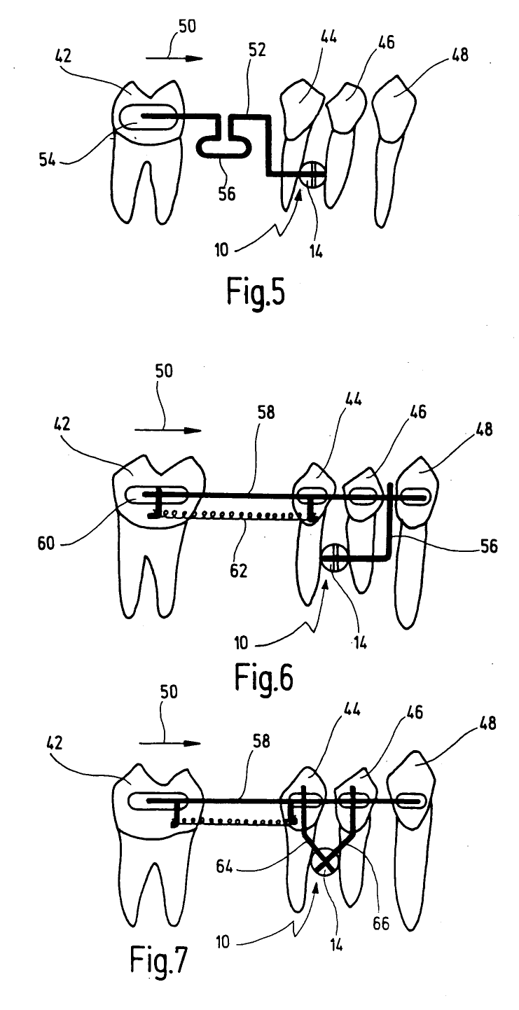

As shown in FIG. 6, a tensioning or retaining element 56 is fixed on the implanted implant 10 and is connected via a brace 58 indirectly to the tooth 42 to be mobilized, which brace is fastened on the teeth 44, 46 and 48 via appropriate brackets. The brace 58 is also connected via a bracket 60 to the tooth 42, but the bracket 60 is displaceable relative to the brace 58. A helical spring-like chain is connected to the bracket 60 on the one hand and to the brace 58 on the tooth 44 and exerts on the tooth 42 a traction in the direction of the arrow 50. Mobilization of the tooth 44 and also of the teeth 46 and 48 is, however, precluded because of fixation thereof via the tensioning or retaining element 56 on the implant 10, so that it is ensured that only the tooth 42 is mobilized as desired.

The arrangement in FIG. 7 is comparable with FIG. 6, but in this case the brace 58 is fixed by means of two tensioning or retaining elements 64 and 66 on the implant 10 in order to form an immobile anchorage point for the mobilization force.

It will be appreciated that the implant 10 can, depending on the case, be implanted both on the inside of the jawbone facing the tongue and on the outside of the jawbone facing away from the tongue, specifically at a point which is most suitable for the purpose of the intended tooth mobilization.

Depending on the case, especially on the size of the mobilization force to be applied, which may also consist of a thrust or of a force rotating a tooth around its long axis, it is possible to use appropriate arrangements of traction, thrust or torsion elements with an implant 10 or a plurality of such implants 10 in order to achieve the desired result of eliminating the tooth malpositioning.

What is claimed is:

1. An orthodontic implant system for tooth mobilization, comprising:
an implant having a shaft which can be implanted in a jawbone, and a head adjoining said shaft at one end of said shaft;
fastening means on said head of said implant for fixing at least one elongate tensioning/retaining element on said head, said fastening means having at least one elongate recess for receiving a section of said at least one tensioning/retaining element, said recess being formed on said head and extending substantially transversely to a longitudinal axis of said shaft and being open on at least one side of said head;
a curable adhesive composition for fixing said section of said at least one tensioning/retaining element in said at least one recess.

2. The implant system of claim 1, wherein said at least one recess is formed as a slit recessed at a free end of said head.

3. The implant system of claim 2, wherein a depth of said slit is such that said slit can receive at least two tensioning/retaining elements one above the other.

4. The implant system of claim 1, wherein said at least one recess is formed as a borehole in said head.

5. The implant system of claim 1, wherein said fastening means have at least two recesses.

6. The implant system of claim 5, wherein said at least two recesses cross one another.

7. The implant system of claim 6, wherein said at least two recesses cross one another at right angles.

8. The implant system of claim 1, wherein a free end of said head has a coning which tapers toward said free end of said head, with said at least one recess being formed in said coning.

9. The implant system of claim 8, wherein a radially inwardly directed undercut adjoins said coning at an end opposite to said tapered free end.

10. The implant system of claim 1, wherein said shaft has a thread for screwing into the jawbone, and a polygon is formed around said head to fit a corresponding tool.

11. The implant system of claim 1, wherein said shaft and said head are formed together in one piece.

12. The implant system of claim 1, wherein said head and said shaft are fabricated from a rod-like solid material in a material-removing process.

13. The implant system of claim 1, wherein said adhesive composition is in ductile form before application to said head and can be cured after application.

14. The implant system of claim 13, wherein said adhesive composition is curable by means of light.

15. An orthodontic implant system for tooth mobilization, comprising:
an implant having a shaft which can be implanted in a jawbone, and a head adjoining said shaft at one end of said shaft;
fastening means on said head of said implant for fixing at least one elongate tensioning/retaining element on said head, said fastening means having at least one elongate recess for receiving a section of said at least one tensioning/retaining element, said recess being formed on said head and extending substantially transversely to a longitudinal axis of said shaft and being open on at least one side of said head, said at least one recess being formed as slit recessed at a free end of said head, and a depth of said slit being such that said slit can receive at least two tensioning or retaining elements one above the other;
a curable adhesive composition for fixing said section of said at least one tensioning/retaining element in said at least one recess.

16. The implant system of claim 15, wherein a free end of said head has a coning which tapers toward said free end of said head, with said at least one recess being formed in said coning.

17. The implant system of claim 16, wherein a radially inwardly directed undercut adjoins said coning at an end opposite to said tapered free end.

18. The implant system of claim 15, wherein said fastening means have at least two recesses.
